(19) United States
(12) Patent Application Publication
(10) Pub. No.: US 2026/0211293 A1
(43) Pub. Date: Jul. 23, 2026

(54) OPTICAL ELEMENT DRIVING MECHANISM

(71) Applicant: Actutek Corporation, Taoyuan City (TW)

(72) Inventors: Chia-Che WU, Taoyuan City (TW); Yi-Ho CHEN, Taoyuan City (TW); Ya-Hsiu WU, Taoyuan City (TW)

(21) Appl. No.: 19/456,673

(22) Filed: Jan. 22, 2026

Related U.S. Application Data
(60) Provisional application No. 63/748,691, filed on Jan. 23, 2025.

(51) Int. Cl. G03B 5/00; G02B 27/64

(52) U.S. Cl. CPC G03B 5/00; G02B 27/64

(57) ABSTRACT

An optical element driving mechanism is provided. The optical element driving mechanism includes a movable part, a fixed part, and a driving assembly. The first movable part is configured to connect an optical element. The movable part is movable relative to the fixed part. The driving assembly is configured to drive the movable part to move.

### CROSS REFERENCE TO RELATED APPLICATIONS

This application claims the benefit of U.S. provisional application No. 63/748,691, filed Jan. 23, 2025, the entirety of which is incorporated by reference herein.

### TECHNICAL FIELD

The present disclosure relates to an optical element driving mechanism, and, in particular, it relates to an optical element driving mechanism having a plurality of movable parts, a sensing assembly, and a plurality of guiding assemblies.

### BACKGROUND

With the development of technology, many modern electronic devices, such as notebook computers, smart phones, and digital cameras, are equipped with photographing and video-recording functionality. As the use of such electronic devices becomes increasingly widespread, product designs not only pursue more stable and improved optical quality but also emphasize convenience and slimness, so as to provide users with more options.

In view of the foregoing, there is a need for an optical element driving mechanism that allows adjustment of the optical photographing focal distance to accommodate different environmental photographing requirements, while reducing operational errors caused by interference with magnetic components during operation, stabilizing internal structures, and providing more stable and improved optical quality.

### BRIEF SUMMARY

The terms “embodiment” and similar expressions (e.g., implementation, arrangement, feature, example, and option) are intended to broadly refer to all subject matter of the present invention and the following claims. Statements containing these terms are to be understood as not limiting the subject matter described herein nor limiting the meaning or scope of the following claims. The embodiments encompassed by the present invention are defined by the claims, not by the summary. This summary provides a high-level overview of various features of the invention and introduces certain concepts that are described in greater detail in the following embodiment sections. This description of the invention is not intended to identify key or essential features of the claimed subject matter, nor is it intended to be used independently to determine the scope of the claimed subject matter. The subject matter should be understood with reference to the appropriate portions of the full specification of the invention, any or all accompanying drawings, and each of the claims.

According to certain aspects of the present disclosure, an optical element driving mechanism is provided. The optical element driving mechanism includes a first movable part, a fixed part, and a driving assembly. The first movable part is configured to connect to an optical element. The first movable part is movable relative to the fixed part. The driving assembly is configured to drive the first movable part to move.

According to certain aspects of the present disclosure, the optical element driving mechanism further includes a second movable part. The second movable part is movable relative to the first movable part in a second dimension, and the second movable part is movable relative to the fixed part in a first dimension and the second dimension. The second movable part includes a body and an installation portion that protrudes from the body toward a recess of the first movable part. The second movable part and the first movable part are arranged along a first axis. The second movable part and the fixed part are arranged along a third axis. When viewed along the third axis, the first movable part and the second movable part at least partially overlap. The first axis, a second axis, and the third axis are non-parallel. The second axis is parallel to a principal axis of the optical element.

The foregoing summary is not intended to present every embodiment or every feature of the present disclosure. Instead, the above summary merely provides examples of some of the novel features and characteristics described herein. When taken together with the drawings and the appended claims, the following detailed description of representative embodiments and modes for carrying out the invention will make the above-mentioned features and advantages, as well as other features and advantages of the present disclosure, apparent. In view of the drawings provided below for the detailed description of various embodiments, additional features of the present disclosure will be apparent to those of ordinary skill in the art.

### BRIEF DESCRIPTION OF THE DRAWINGS

The present disclosure can be more fully understood by reading the subsequent detailed description and examples with references made to the accompanying drawings. These drawings illustrate only exemplary embodiments and thus should not be regarded as limiting the various embodiments or the scope of the claims.

FIG. 1A is a perspective view of an optical element driving mechanism, an optical element, and an aperture assembly, according to certain aspects of the present disclosure.

FIG. 1B is a perspective view of the optical element driving mechanism, the optical element, and the aperture assembly, according to certain aspects of the present disclosure, wherein the housing is removed for illustrative purposes.

FIG. 2 is an exploded perspective view of the optical element driving mechanism, the optical element, and the aperture assembly, according to certain aspects of the present disclosure.

FIG. 3A is a front perspective view of a first movable part of the optical element driving mechanism, according to certain aspects of the present disclosure.

FIG. 3B is a rear perspective view of the first movable part, according to certain aspects of the present disclosure.

FIG. 4A is a front perspective view of a second movable part of the optical element driving mechanism, according to certain aspects of the present disclosure.

FIG. 4B is a top view of the second movable part, according to certain aspects of the present disclosure.

FIG. 5 is a top view of a third movable part of the optical element driving mechanism, according to certain aspects of the present disclosure.

FIG. 6 is an enlarged top view of the optical element driving mechanism shown in FIG. 1B, particularly illustrating a circuit assembly of the optical element driving mechanism, according to certain aspects of the present disclosure.

FIG. 7A is an enlarged perspective view of the optical element driving mechanism shown in FIG. 1B, particularly illustrating a portion of a sensing assembly of the optical element driving mechanism, wherein the fixed part is removed and the second movable part is shown in dashed lines for illustrative purposes, according to certain aspects of the present disclosure.

FIG. 7B is a sectional view of the optical element driving mechanism taken along line A-A of FIG. 1A, according to certain aspects of the present disclosure.

FIG. 8A is an enlarged perspective view of the optical element driving mechanism shown in FIG. 1B, particularly illustrating another portion of the sensing assembly of the optical element driving mechanism, according to certain aspects of the present disclosure, wherein the fixed part is removed and the second movable part is shown in dashed lines for illustrative purposes.

FIG. 8B is a sectional view of the optical element driving mechanism taken along line B-B of FIG. 1A, according to certain aspects of the present disclosure.

FIG. 9 is a top view of the third movable part, a third guiding assembly, the second movable part, and the optical element of the optical element driving mechanism, according to certain aspects of the present disclosure, wherein the third movable part is shown in dashed lines for illustrative purposes.

FIG. 10 is a perspective view of the third movable part, the second movable part, the first movable part, a second guiding assembly, and the optical element, according to certain aspects of the present disclosure, wherein the first movable part is shown in dashed lines for illustrative purposes.

FIG. 11 is a right side view of the optical element driving mechanism, according to certain aspects of the present disclosure, wherein a portion of the fixed part is removed and a base of the fixed part is shown in dashed lines for illustrative purposes.

FIG. 12 is a perspective view of the optical element driving mechanism, the optical element, and the aperture assembly, according to certain aspects of the present disclosure, wherein a portion of the fixed part is removed and the base is shown in dashed lines for illustrative purposes.

FIG. 13A is a perspective view of another optical element driving mechanism, an optical element, and an aperture assembly, according to certain aspects of the present disclosure, wherein the fixed part and a first guiding assembly are removed and the first movable part is shown in dashed lines for illustrative purposes.

FIG. 13B is a perspective view of the optical element driving mechanism, the optical element, and the aperture assembly, according to certain aspects of the present disclosure, wherein a portion of the fixed part is removed and a base is shown in dashed lines for illustrative purposes.

FIG. 14A is a perspective view of yet another optical element driving mechanism, an optical element, and an aperture assembly, according to certain aspects of the present disclosure, wherein the fixed part and the first guiding assembly are removed and the first movable part is shown in dashed lines for illustrative purposes.

FIG. 14B is a perspective view of the optical element driving mechanism, the optical element, and the aperture assembly, according to certain aspects of the present disclosure, wherein a portion of the fixed part is removed and a base is shown in dashed lines for illustrative purposes.

### DETAILED DESCRIPTION

Multiple embodiments are described with reference to the drawings, in which like reference numerals are used throughout to designate similar or equivalent elements. The drawings are not drawn to scale, and are provided merely to illustrate the features and characteristics of the present disclosure. It should be understood that numerous specific details, relationships, and methods are described to provide a thorough understanding. However, one of ordinary skill in the art will readily appreciate that multiple embodiments may be practiced without one or more of the specific details, or using other methods. In some instances, well-known structures or operations are not shown in detail for purposes of illustration. The various embodiments are not limited to the illustrated sequence of actions or events, as some actions may occur in different sequences and/or concurrently with other actions or events. Furthermore, not all illustrated actions or events are required for practicing certain aspects and features of the present disclosure.

For purposes of the present embodiment, unless explicitly stated otherwise, the singular includes the plural and vice versa. The term “including” means “including but not limited to.” In addition, approximate terms such as “about,” “almost,” “substantially,” or “approximately,” and similar expressions may be understood herein to mean, for example, “at,” “near,” “nearly at,” “within 3-5% of,” “within acceptable manufacturing tolerances,” or any logical combination thereof. Additionally, the terms “vertical” or “horizontal” are intended to further include directions within “3-5% of” vertical or horizontal, respectively. Furthermore, directional terms such as “top,” “bottom,” “left,” “right,” “upper,” and “lower” are intended to refer to equivalent directions as depicted in the referenced illustrations; as understood from the context of the referenced object or component, such as its customary orientation; or other similar descriptions.

It will be understood that although the terms “first,” “second,” and the like may be used herein to describe various elements, layers, and/or portions, such elements, layers, and/or portions should not be limited by these terms, which are used merely to distinguish one element, layer, or portion from another. Thus, a first element, layer, and/or portion discussed below may be referred to as a second element, layer, and/or portion without departing from the teachings of certain embodiments of the present disclosure. Additionally, for brevity, the terms “first,” “second,” and the like may be omitted in the specification when distinguishing between different elements. Without departing from the scope defined by the appended claims, the first element and/or second element recited in the claims may be interpreted as any element that fits the description in the specification.

It should be noted that the technical solutions provided by different embodiments below may be interchanged, combined, or used in mixed form to constitute another embodiment, so long as doing so does not depart from the spirit of the present disclosure.

The present disclosure relates to an optical element driving mechanism having a driving assembly, movable parts, and guiding assemblies, which drive the movable parts and an optical element to move flexibly in various directions, thereby adjusting the imaging performance of the optical element driving mechanism to accommodate different photographing requirements.

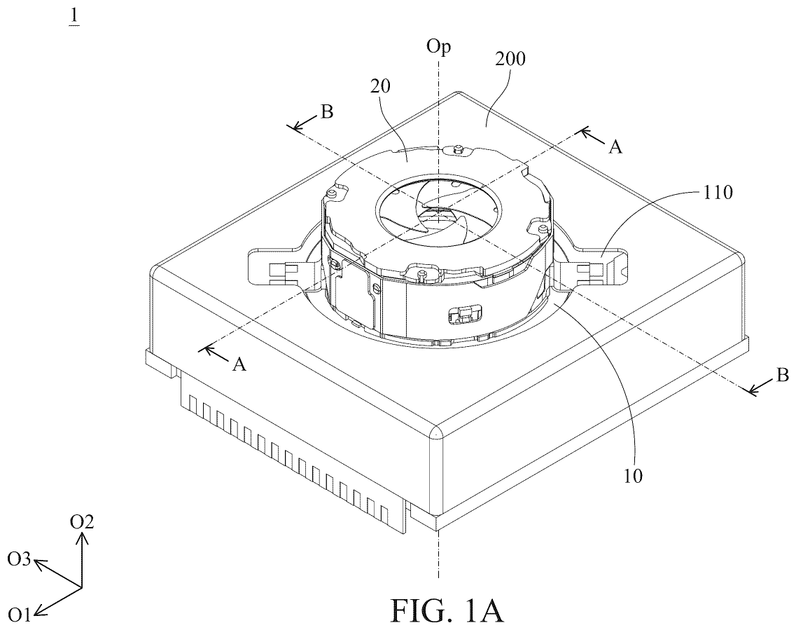

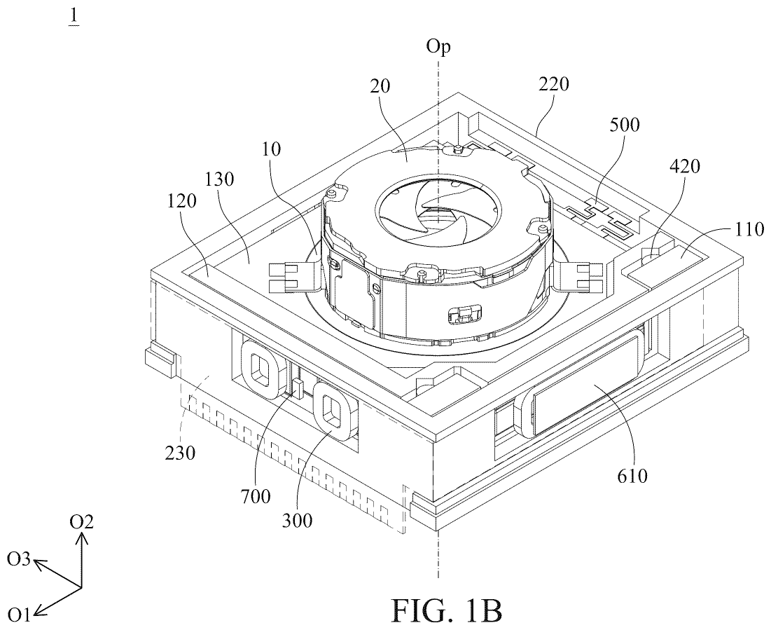

Please refer first to FIGS. 1A and 1B together. FIG. 1A is a perspective view of an optical element driving mechanism 1, an optical element 10, and an aperture assembly 20 according to certain aspects of the present disclosure. FIG. 1B is a perspective view of the optical element driving mechanism 1, the optical element 10, and the aperture assembly 20, according to certain aspects of the present disclosure, wherein a housing 210 is removed for illustrative purposes.

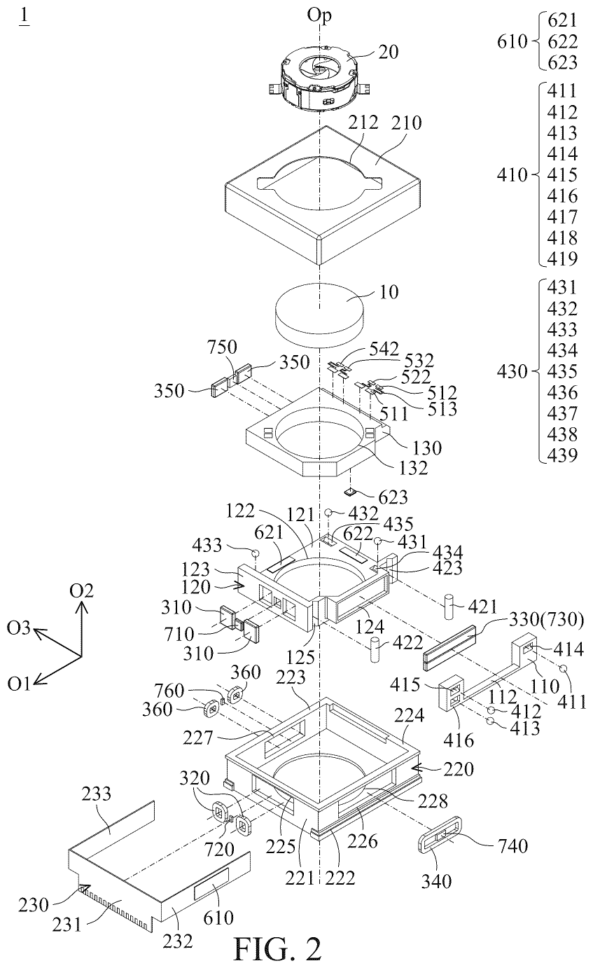

Next, please refer to FIG. 2. FIG. 2 is an exploded perspective view of the optical element driving mechanism 1, the optical element 10, and the aperture assembly 20, according to certain aspects of the present disclosure.

The optical element driving mechanism 1 includes a first movable part 110, a second movable part 120, a third movable part 130, a fixed part 200, a driving assembly 300, a first guiding assembly 410, a second guiding assembly 420, a third guiding assembly 430, a circuit assembly 500, a first stabilizing assembly 610, a second stabilizing assembly 620, and a sensing assembly 700. The first movable part 110 is connected to the optical element 10 and the aperture assembly 20. The optical element 10 may be, for example, an optical lens. The aperture assembly 20 may be formed of optical blades, for example.

The first movable part 110, the second movable part 120, and the third movable part 130 are movable relative to the fixed part 200. The driving assembly 300 drives the first movable part 110, the second movable part 120, and the third movable part 130 to move. The first movable part 110 is movably connected to the fixed part 200 via the first guiding assembly 410. The second movable part 120 is movably connected to the first movable part 110 via the second guiding assembly 420. The third movable part 130 is movably connected to the second movable part 120 via the third guiding assembly 430. The circuit assembly 500 is configured to connect to an external circuit. The circuit assembly 500 is electrically connected to the aperture assembly 20 and the optical element driving mechanism 1. The first stabilizing assembly 610 and the second stabilizing assembly 620 reinforce internal structures of the optical element driving mechanism 1. The sensing assembly 700 is configured to sense movement of the optical element 10 relative to the fixed part 200.

Incident light from an external environment passes through the aperture assembly 20, the optical element 10, and the optical element driving mechanism 1, and the incident light has a principal axis Op. That is, the principal axis Op passes through the aperture assembly 20, the optical element 10, and the optical element driving mechanism 1.

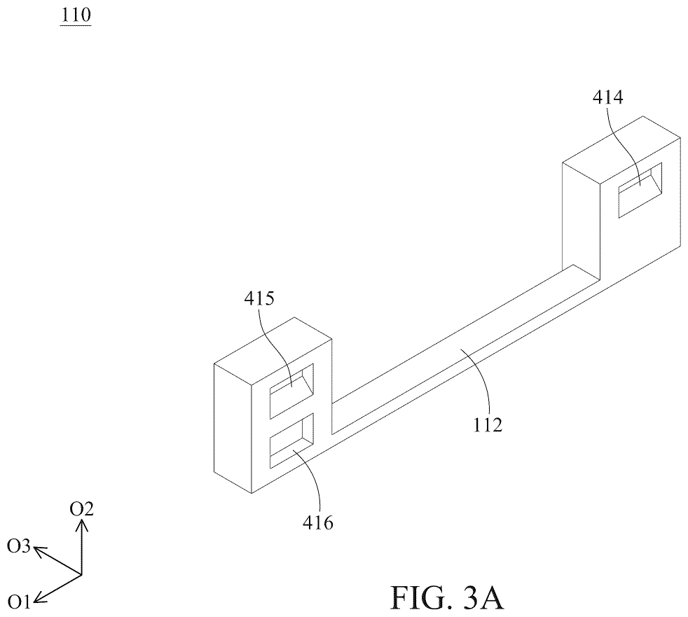

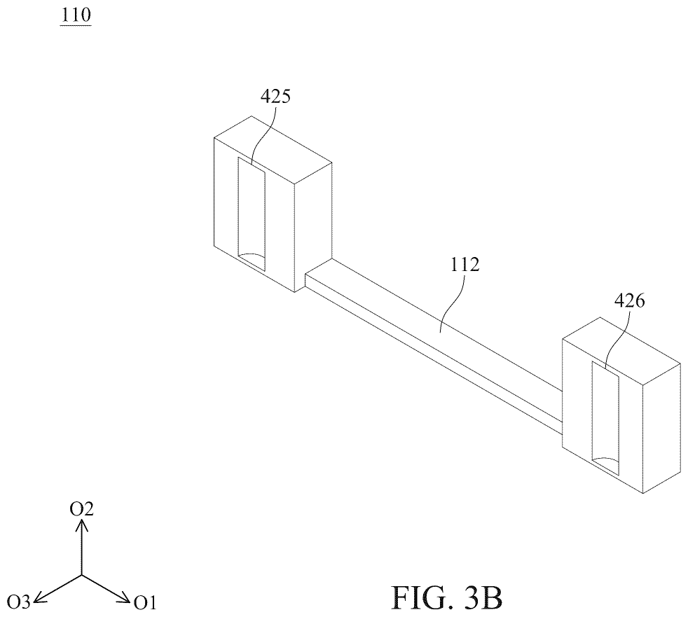

Next, please refer to FIGS. 3A and 3B together. FIG. 3A is a front perspective view of the first movable part 110 of the optical element driving mechanism 1, according to certain aspects of the present disclosure. FIG. 3B is a rear perspective view of the first movable part 110, according to certain aspects of the present disclosure.

The second movable part 120 and the first movable part 110 are arranged along a first axis O1. The second movable part 120 and the fixed part 200 are arranged along a second axis O2. When viewed along a third axis O3, the first movable part 110 and the second movable part 120 at least partially overlap. The first axis O1, the second axis O2, and the third axis O3 are non-parallel. The second axis O2 is parallel to the principal axis Op of the optical element 10.

The first movable part 110 is disposed between the second movable part 120 and the fixed part 200. The first movable part 110 has a recess 112, corresponding to an installation portion 124 of the second movable part 120. The first movable part 110 is movably connected to the fixed part 200 via the first guiding assembly 410 and is movably connected to the second movable part 120 via the second guiding assembly 420. First guiding grooves 414, 415, and 416 of the first guiding assembly 410 are disposed on the first movable part 110. In the present embodiment, the first guiding grooves 414, 415, and 416 have elongated structures extending along the first axis O1, thereby enabling the first movable part 110 to move relative to the fixed part 200 in a first dimension along the first axis O1.

Second guiding grooves 425 and 426 of the second guiding assembly 420 are likewise disposed on the first movable part 110. In the present embodiment, the second guiding grooves 425 and 426 have elongated structures extending along the second axis O2, thereby enabling the first movable part 110 to move relative to the second movable part 120 in a second dimension along the second axis O2.

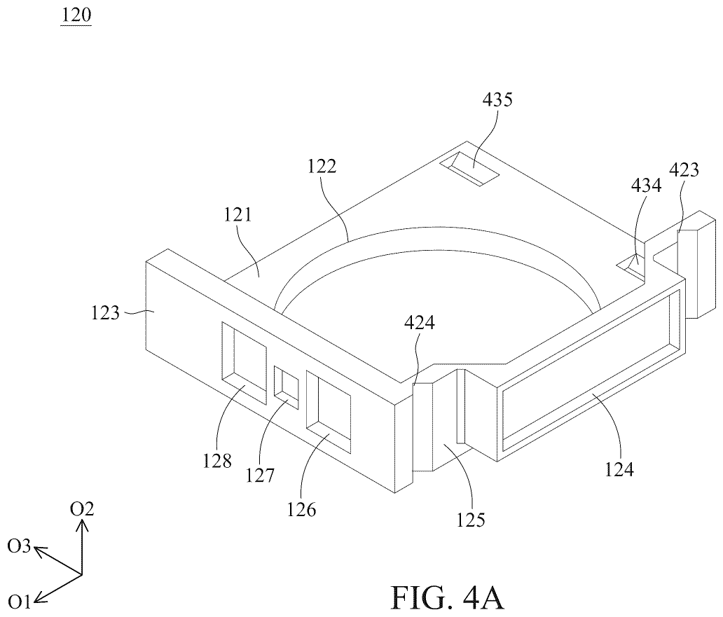

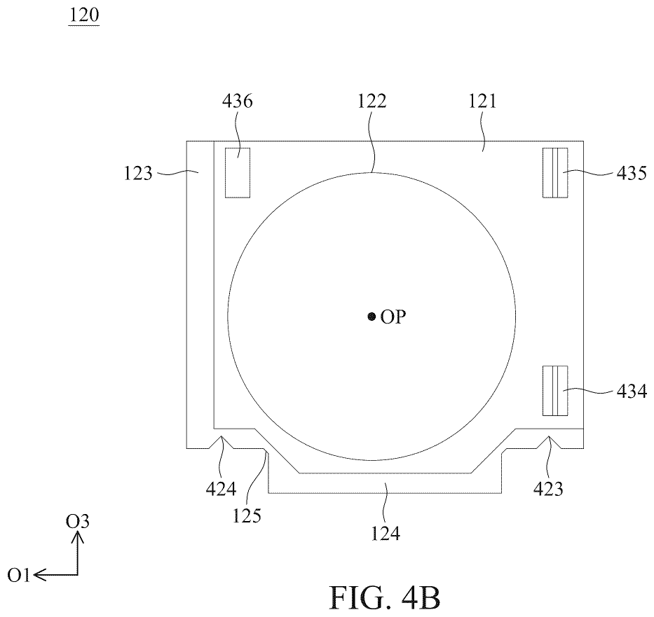

Next, please refer next to FIGS. 4A and 4B together. FIG. 4A is a front perspective view of the second movable part 120 of the optical element driving mechanism 1, according to certain aspects of the present disclosure. FIG. 4B is a top view of the second movable part 120, according to certain aspects of the present disclosure.

The second movable part 120 includes a body 121, an opening 122, sidewalls 123 and 125, an installation portion 124, and receiving portions 126, 127, and 128. The principal axis Op passes through the opening 122. The sidewalls 123 and 125 extend from the body 121. The installation portion 124 is disposed on the sidewall 125 and extends from the body 121 into the recess 112 of the first movable part 110. That is, the installation portion 124 is fixedly disposed within the recess 112. The receiving portions 126, 127, and 128 are configured to respectively receive components of the driving assembly 300 and the sensing assembly 700.

The second movable part 120 is movably connected to the first movable part 110 via the second guiding assembly 420 and is movably connected to the third movable part 130 via the third guiding assembly 430. Second guiding grooves 423 and 424 of the second guiding assembly 420 are disposed on the sidewall 125 of the second movable part 120. In the present embodiment, the second guiding grooves 423 and 424 have elongated structures extending along the second axis O2, thereby enabling the second movable part 120 to move relative to the first movable part 110 in the second dimension along the second axis O2.

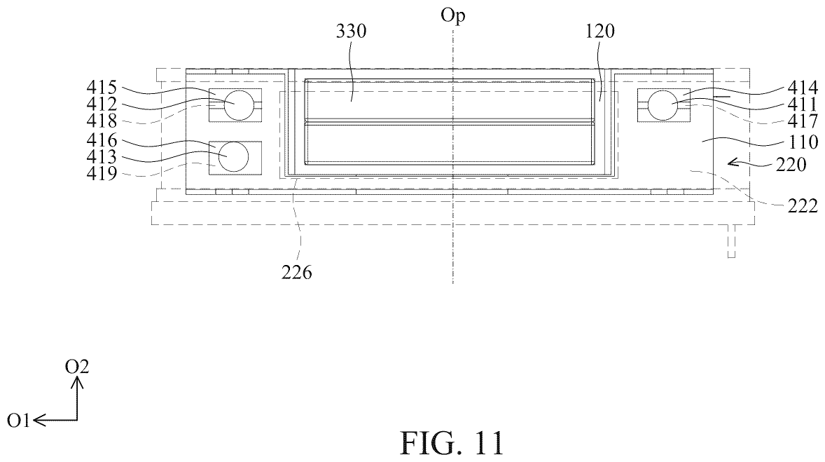

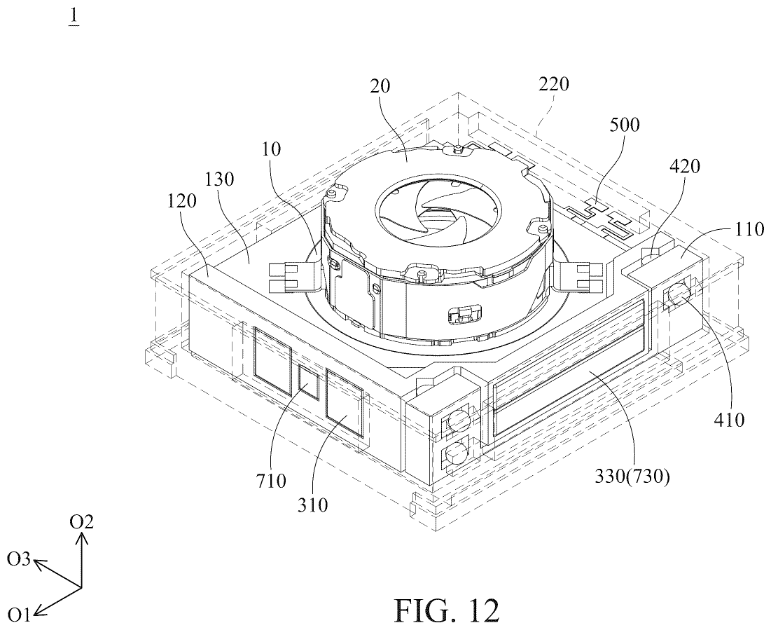

Third guiding grooves 434, 435, and 436 of the third guiding assembly 430 are likewise disposed on the second movable part 120. In the present embodiment, the third guiding grooves 434, 435, and 436 have elongated structures extending along the third axis O3, thereby enabling the second movable part 120 to move relative to the third movable part 130 in a third dimension along the third axis O3. Movement of the second movable part 120 may drive movement of the third movable part 130 (which will be described in detail below with reference to FIGS. 11 and 12).

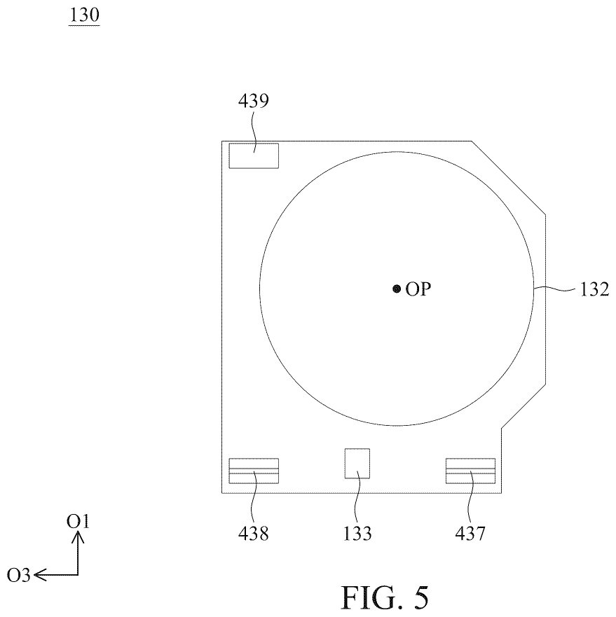

Next, please refer to FIG. 5. FIG. 5 is a top view of the third movable part 130 of the optical element driving mechanism 1, according to certain aspects of the present disclosure.

The third movable part 130 includes an opening 132 and a receiving portion 133. The principal axis Op passes through the opening 132. The receiving portion 133 receives components of the second stabilizing assembly 620. The optical element 10 is disposed within the opening 132 and is fixedly connected to the third movable part 130, which is in turn connected to the second movable part 120 via the third guiding assembly 430, to the first movable part 110 via the second guiding assembly 420, and to the fixed part 200 via the first guiding assembly 410 (which will be described in detail below with reference to FIGS. 11 and 12).

The third movable part 130 is connected to the optical element 10. The third movable part 130 is movably connected to the second movable part 120 via the third guiding assembly 430. Third guiding grooves 437, 438, and 439 of the third guiding assembly 430 are disposed on the third movable part 130. In the present embodiment, the third guiding grooves 437, 438, and 439 have elongated structures extending along the third axis O3, thereby enabling the third movable part 130 to move relative to the second movable part 120 in a third dimension along the third axis O3.

Next, please refer again to FIG. 2. The fixed part 200 includes a housing 210, a base 220, and a frame 230. The housing 210 includes an opening 212. The principal axis Op passes through the opening 212. The housing 210 and the base 220 are fixedly connected. When viewed along the second axis O2, the base 220 has a polygonal shape including a first side 221, a second side 222, a third side 223, and a fourth side 224. The first side 221 and the second side 222 are non-parallel. The base 220 further includes receiving portions 225, 226, and 227, and an opening 228.

The base 220 is fixedly connected to the frame 230. The frame 230 is fixedly connected to the first side 221, the second side 222, and the third side 223. The frame 230 includes a main body 231 and sidewalls 232 and 233. The main body 231 includes an output terminal configured to output electric signals of the optical element driving mechanism 1.

The driving assembly 300 includes a first driving unit 310, a second driving unit 320, a third driving unit 330, a fourth driving unit 340, a fifth driving unit 350, and a sixth driving unit 360. The first driving unit 310 is fixedly disposed on the second movable part 120. The second driving unit 320 corresponds to the first driving unit 310. The second driving unit 320 is disposed on the first side 221.

The first driving unit 310 and the second driving unit 320 may be, for example, driving units such as magnets and coils, piezoelectric elements, stepper motors, or shape memory alloys. In the present embodiment, the first driving unit 310 includes two magnetic elements, and the second driving unit 320 includes two coils. The two magnetic elements of the first driving unit 310 are individually disposed in the receiving portions 126 and 128 of the second movable part 120. The second driving unit 320 is fixedly disposed on the main body 231 of the frame 230. When the frame 230 is assembled to the base 220, the second driving unit 320 enters the receiving portion 225 to interact with the first driving unit 310.

By an electromagnetic driving force generated between the first driving unit 310 and the second driving unit 320 along the first axis O1, the first driving unit 310 moves relative to the second driving unit 320 along the first axis O1. Accordingly, the second movable part 120 moves relative to the base 220 and the frame 230 along the first axis O1.

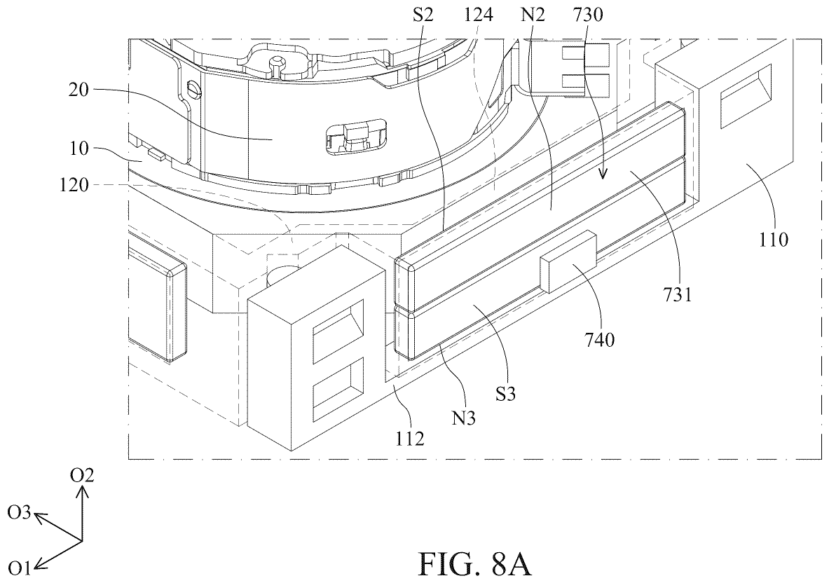

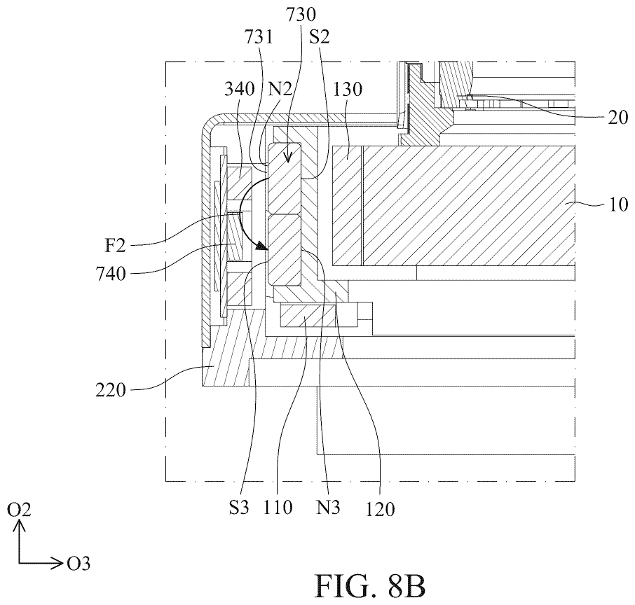

The third driving unit 330 is fixedly disposed on the second movable part 120. The fourth driving unit 340 corresponds to the third driving unit 330. The fourth driving unit 340 is disposed on the second side 222. In the present embodiment, the third driving unit 330 includes two magnetic elements fixed with opposing magnetic poles (as described in detail below with reference to FIG. 8A), and the fourth driving unit 340 includes a coil. The two magnetic elements of the third driving unit 330 are disposed in the installation portion 124 of the second movable part 120 and protrude toward the recess 112 of the first movable part 110. The fourth driving unit 340 is fixedly disposed on the sidewall 232 of the frame 230. When the frame 230 is assembled to the base 220, the fourth driving unit 340 enters the receiving portion 226 to interact with the third driving unit 330.

By an electromagnetic driving force generated between the third driving unit 330 and the fourth driving unit 340 along the second axis O2, the third driving unit 330 moves relative to the fourth driving unit 340 along the second axis O2. Accordingly, the second movable part 120 moves relative to the base 220 and the frame 230 along the second axis O2.

The fifth driving unit 350 is fixedly disposed on the third movable part 130. The sixth driving unit 360 corresponds to the fifth driving unit 350. The sixth driving unit 360 is disposed on the third side 223.

In the present embodiment, the fifth driving unit 350 includes two magnetic elements, and the sixth driving unit 360 includes two coils. The two magnetic elements of the fifth driving unit 350 are individually disposed on the third movable part 130. The sixth driving unit 360 is fixedly disposed on the sidewall 233 of the frame 230. When the frame 230 is assembled to the base 220, the sixth driving unit 360 enters the receiving portion 227 to interact with the fifth driving unit 350.

By an electromagnetic driving force generated between the fifth driving unit 350 and the sixth driving unit 360 along the third axis O3, the fifth driving unit 350 moves relative to the sixth driving unit 360 along the third axis O3. Accordingly, the third movable part 130 moves relative to the base 220 and the frame 230 along the third axis O3.

The multiple sets of driving provided by the first driving unit 310, the second driving unit 320, the third driving unit 330, the fourth driving unit 340, the fifth driving unit 350, and the sixth driving unit 360 of the driving assembly 300 allow adjustment of an optical focusing distance of the optical element 10 to accommodate different external photographing requirements, and provide sufficient driving force to drive the third movable part 130, the first movable part 110, the second movable part 120, and the optical element 10.

The first guiding assembly 410 is disposed between the first movable part 110 and the fixed part 200. The first movable part 110 is movable relative to the fixed part 200 via the first guiding assembly 410.

In the present embodiment, the first guiding assembly 410 includes a combination of three balls 411, 412, and 413 located in six first guiding grooves. Among them, first guiding grooves 414, 415, and 416 are disposed on the first movable part 110, and first guiding grooves 417, 418, and 419 are disposed on the base 220 (see FIGS. 11 and 12). The first guiding assembly 410 is disposed between the base 220 and the first movable part 110, and the first movable part 110 is movable relative to the base 220 via the first guiding assembly 410.

In the present embodiment, the second guiding assembly 420 includes a combination of two guide rods 421 and 422 located in four second guiding grooves. Among them, second guiding grooves 423 and 424 are disposed on the second movable part 120, and second guiding grooves 425 and 426 are disposed on the first movable part 110. The second guiding assembly 420 is disposed between the second movable part 120 and the first movable part 110, and the second movable part 120 is movable relative to the first movable part 110 via the second guiding assembly 420. The first guiding assembly 410 and the second guiding assembly 420 are arranged along the third axis O3.

In the present embodiment, the third guiding assembly 430 includes a combination of three balls 431, 432, and 433 located in six third guiding grooves. Among them, third guiding grooves 434, 435, and 436 are disposed on the second movable part 120, and third guiding grooves 437, 438, and 439 are disposed on the third movable part 130. The third guiding assembly 430 is disposed between the third movable part 130 and the second movable part 120, and the third movable part 130 is movable relative to the second movable part 120 via the third guiding assembly 430. The third guiding assembly 430 and the first guiding assembly 410 are arranged along the third axis O3.

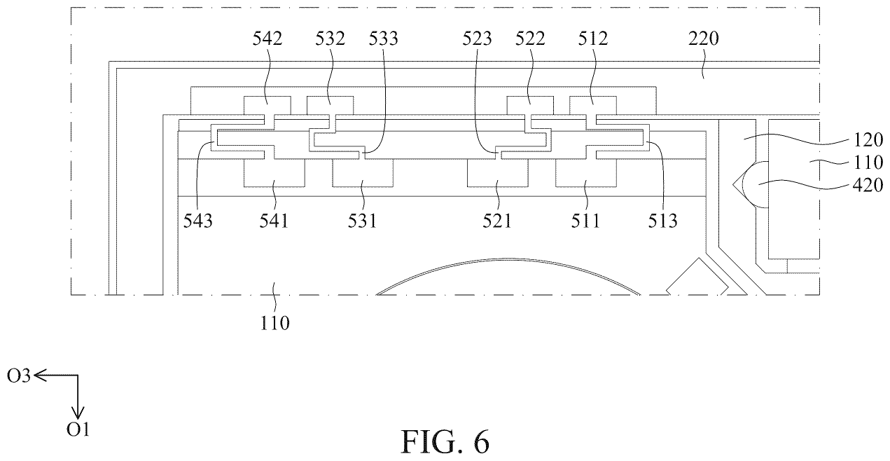

Please refer next to FIG. 6. FIG. 6 is an enlarged top view of the optical element driving mechanism 1 shown in FIG. 1B, according to certain aspects of the present disclosure, particularly illustrating the circuit assembly 500 of the optical element driving mechanism 1.

The circuit assembly 500 is configured to connect to an external circuit (not shown, e.g., an output circuit for the optical element driving mechanism 1). When viewed along the second axis O2, the circuit assembly 500 is located on the fourth side 224. The circuit assembly 500 includes a first movable part connecting terminal 511, a first fixed part connecting terminal 512, a first elastic portion 513, a second movable part connecting terminal 521, a second fixed part connecting terminal 522, a second elastic portion 523, a third movable part connecting terminal 531, a third fixed part connecting terminal 532, a third elastic portion 533, a fourth movable part connecting terminal 541, a fourth fixed part connecting terminal 542, and a fourth elastic portion 543.

The first movable part connecting terminal 511, the second movable part connecting terminal 521, the third movable part connecting terminal 531, and the fourth movable part connecting terminal 541 are at least partially fixedly connected to the first movable part 110, the second movable part 120, or the third movable part 130. In the present embodiment, the first movable part connecting terminal 511, the second movable part connecting terminal 521, the third movable part connecting terminal 531, and the fourth movable part connecting terminal 541 are at least partially fixedly connected to the third movable part 130. The first fixed part connecting terminal 512 is at least partially fixedly connected to the base 220 of the fixed part 200. The first movable part connecting terminal 511 is connected to the first fixed part connecting terminal 512 via the first elastic portion 513. The second movable part connecting terminal 521 is connected to the second fixed part connecting terminal 522 via the second elastic portion 523. The third movable part connecting terminal 531 is connected to the third fixed part connecting terminal 532 via the third elastic portion 533. The fourth movable part connecting terminal 541 is connected to the fourth fixed part connecting terminal 542 via the fourth elastic portion 543.

The second fixed part connecting terminal 522 is at least partially fixedly connected to the fixed part 200, and the second fixed part connecting terminal 522 is electrically independent from the first fixed part connecting terminal 512. The third fixed part connecting terminal 532 is at least partially fixedly connected to the fixed part 200, and the third fixed part connecting terminal 532 is electrically independent from the first fixed part connecting terminal 512 and the second fixed part connecting terminal 522. The fourth fixed part connecting terminal 542 is at least partially fixedly connected to the fixed part 200, and the fourth fixed part connecting terminal 542 is electrically independent from the first fixed part connecting terminal 512, the second fixed part connecting terminal 522, and the third fixed part connecting terminal 532.

When viewed along the second axis O2, the first fixed part connecting terminal 512, the second fixed part connecting terminal 522, the third fixed part connecting terminal 532, and the fourth fixed part connecting terminal 542 are all disposed on the fourth side 224.

Please refer again to FIG. 2. The first stabilizing assembly 610 is disposed on the sidewall 232 of the frame 230. The first stabilizing assembly 610 is magnetically permeable and is configured to attract toward the third driving unit 330 to generate a first stabilizing force along the third axis O3. The first stabilizing force is applied to the second movable part 120, causing the second movable part 120 to abut against the frame 230 of the fixed part 200. When the first stabilizing force is applied to the second movable part 120, the first movable part 110 abuts against the fixed part 200. The direction of the first stabilizing force is not parallel to the second axis O2.

The second stabilizing assembly 620 includes magnetic permeability plates 621 and 622, and a magnetic element 623. The magnetic permeability plates 621 and 622 are disposed on the second movable part 120, and the magnetic element 623 is disposed in the receiving portion 133 of the third movable part 130. The magnetic element 623 attracts toward the magnetic permeability plates 621 and 622 to generate a second stabilizing force along the second axis O2, which is applied to the third movable part 130, causing the third movable part 130 to abut against the second movable part 120. The direction of the first stabilizing force is not parallel to the direction of the second stabilizing force.

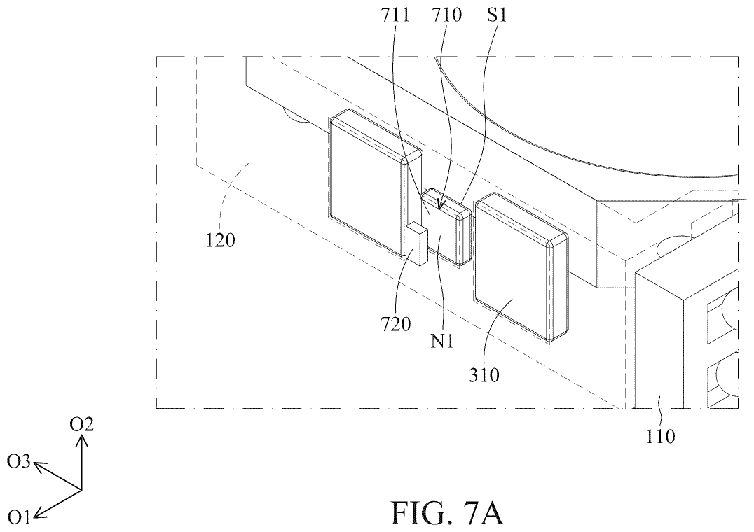

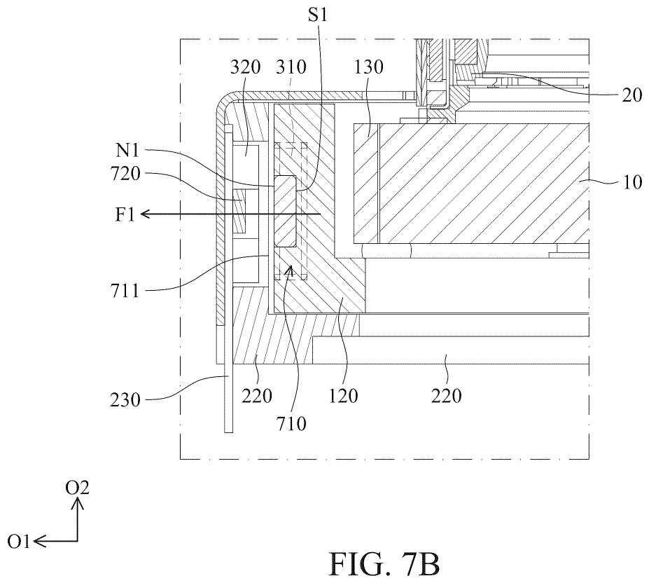

Please refer to FIGS. 7A and 7B next. FIG. 7A is an enlarged perspective view of the optical element driving mechanism 1 shown in FIG. 1B according to certain aspects of the present disclosure, particularly illustrating a portion of the sensing assembly 700 of the optical element driving mechanism 1. For illustrative purposes, the fixed part 200 is removed, and the second movable part 120 is shown in dashed lines.

FIG. 7B is a sectional view of the optical element driving mechanism 1 taken along line A-A of FIG. 1A according to certain aspects of the present disclosure.

The sensing assembly 700 includes a first reference element 710, a first sensing element 720, a second reference element 730, a second sensing element 740, a third reference element 750, and a third sensing element 760.

The first reference element 710 is disposed in the receiving portion 127 of the second movable part 120. The first reference element 710 includes a first surface 711, a first S pole S1, and a first N pole N1. The first S pole S1 and the first N pole N1 are arranged along the first axis O1. The first sensing element 720 is disposed on the main body 231 of the frame 230. The first surface 711 faces the first sensing element 720, and a normal vector of the first surface 711 is parallel to the first axis O1. Along the first axis O1, the first sensing element 720 and the first N pole N1 at least partially overlap.

The first sensing element 720 corresponds to the first reference element 710. By sensing movement of the first reference element 710 by means of the first sensing element 720, movement of the second movable part 120 relative to the fixed part 200 can be determined. Please refer to FIG. 7B, an arrow F1 in the figure illustrates the magnetic field direction of the first S pole S1 and the first N pole N1 of the first reference element 710. The first sensing element 720 senses the magnetic field strength of the first reference element 710 in the direction of the arrow F1, and thus senses movement of the second movable part 120 relative to the fixed part 200 along the first axis O1. Since the second movable part 120 drives the third movable part 130 and the optical element 10 to move, the first sensing element 720 senses movement of the optical element 10 along the first axis O1.

Please refer next to FIGS. 8A and 8B. FIG. 8A is an enlarged perspective view of the optical element driving mechanism 1 shown in FIG. 1B according to certain aspects of the present disclosure, particularly illustrating another portion of the sensing assembly 700 of the optical element driving mechanism 1. For illustrative purposes, the fixed part 200 is removed, and the second movable part 120 is shown in dashed lines.

FIG. 8B is a sectional view of the optical element driving mechanism 1 taken along line B-B of FIG. 1A according to certain aspects of the present disclosure.

In the present embodiment, the second reference element 730 and the third driving unit 330 are the same set of magnetic elements. The second reference element 730 is disposed in the installation portion 124 of the second movable part 120. The second reference element 730 includes a second surface 731, a second N pole N2, a second S pole S2, a third N pole N3, and a third S pole S3. The second S pole S2 and the second N pole N2 of one magnetic element are arranged along the third axis O3, and the third S pole S3 and the third N pole N3 of the other magnetic element are arranged along the third axis O3. However, an arrangement direction of the third S pole S3 and the third N pole N3 is the opposite of an arrangement direction of the second S pole S2 and the second N pole N2. That is, the second N pole N2 and the second S pole S2 are arranged along the third axis O3 in a forward direction, while the third N pole N3 and the third S pole S3 are arranged along the third axis O3 in a reverse direction. The second surface 731 is parallel to the second axis O2. The second surface 731 faces the second sensing element 740. A normal vector of the second surface 731 is parallel to the third axis O3.

The second sensing element 740 is disposed on the sidewall 232 of the frame 230. The second sensing element 740 corresponds to the second reference element 730 and is configured to sense movement of the optical element 10 along the second axis O2. When viewed along the third axis O3, the second reference element 730 and the second sensing element 740 at least partially overlap.

By sensing movement of the second reference element 730 via the second sensing element 740, movement of the second movable part 120 relative to the fixed part 200 can be determined. Please refer to FIG. 8B, an arrow F2 in the figure illustrates the magnetic field directions of the second N pole N2, the second S pole S2, the third N pole N3, and the third S pole S3 of the second reference element 730. The second sensing element 740 senses, at its position, a component of the magnetic field of the second reference element 730 along the second axis O2 (corresponding to arrow F2), and thus senses movement of the second movable part 120 relative to the fixed part 200 along the second axis O2. Since the second movable part 120 drives the third movable part 130 and the optical element 10 to move, the second sensing element 740 senses movement of the optical element 10 along the second axis O2.

The third reference element 750 is disposed on the third movable part 130. The third sensing element 760 is disposed on the sidewall 233 of the frame 230. Along the third axis O3, the third reference element 750 and the third sensing element 760 at least partially overlap.

The third sensing element 760 corresponds to the third reference element 750. By sensing movement of the third reference element 750 via the third sensing element 760, movement of the third movable part 130 relative to the fixed part 200 can be determined. The third sensing element 760 senses the magnetic field strength of the third reference element 750, and thus senses movement of the third movable part 130 relative to the fixed part 200 along the third axis O3. Since the third movable part 130 drives the optical element 10 to move, the third sensing element 760 senses movement of the optical element 10 along the third axis O3.

In the optical element driving mechanism 1, the principal axis Op sequentially passes through the aperture assembly 20, the opening 212 of the housing 210, the optical element 10, the opening 132 of the third movable part 130, the opening 122 of the second movable part 120, and the opening 228 of the base 220, thus passing through the entire optical element driving mechanism 1.

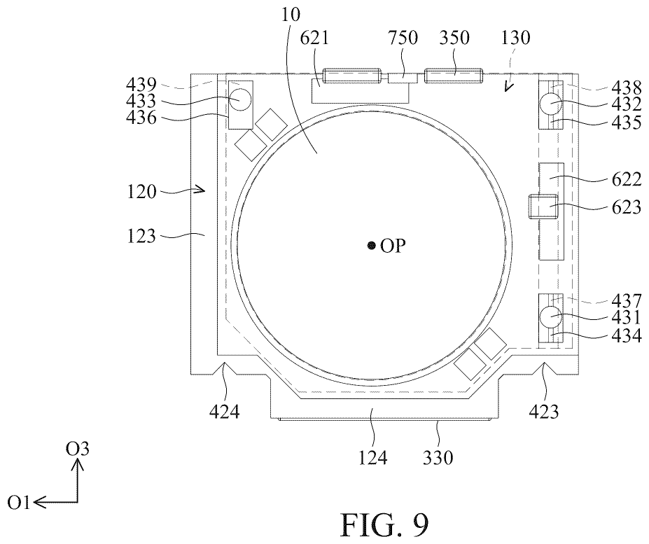

Please refer next to FIGS. 9 to 12. The movement of the first movable part 110, the second movable part 120, the third movable part 130, the optical element 10, the first guiding assembly 410, the second guiding assembly 420, and the third guiding assembly 430 relative to the fixed part 200 will be described.

FIG. 9 is a top view of the third movable part 130, the third guiding assembly 430, the second movable part 120, and the optical element 10 of the optical element driving mechanism 1 according to certain aspects of the present disclosure, wherein the third movable part 130 is shown in dashed lines for illustrative purposes.

As described above, the ball 431 of the third guiding assembly 430 is movably received between the third guiding groove 434 of the second movable part 120 and the third guiding groove 437 of the third movable part 130, the ball 432 is movably received between the third guiding groove 435 of the second movable part 120 and the third guiding groove 438 of the third movable part 130, and the ball 433 is movably received between the third guiding groove 436 of the second movable part 120 and the third guiding groove 439 of the third movable part 130. Since the third guiding grooves 434, 435, 436, 437, 438, and 439 extend along the third axis O3, the third movable part 130 drives the optical element 10 to move relative to the second movable part 120 along the third axis O3.

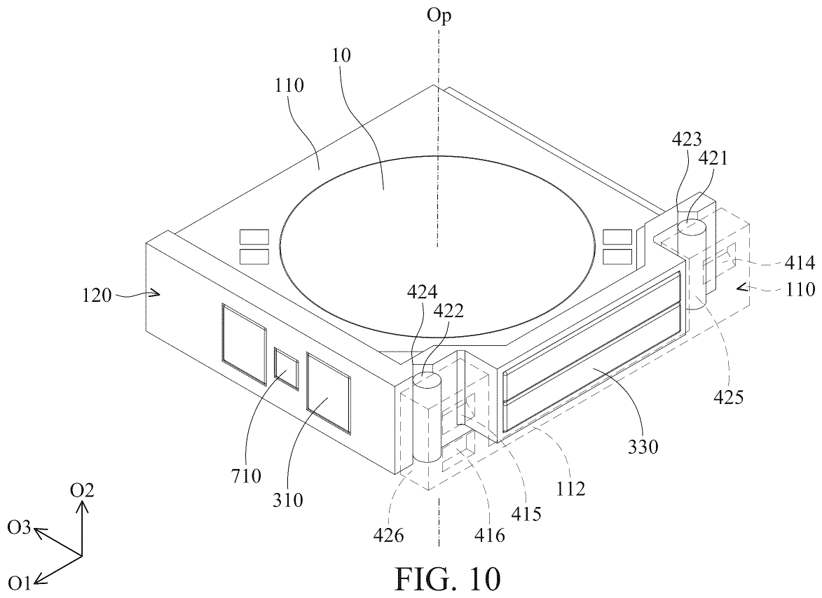

FIG. 10 is a perspective view of the third movable part 130, the second movable part 120, the first movable part 110, the second guiding assembly 420, and the optical element 10 of the optical element driving mechanism 1 according to certain aspects of the present disclosure, wherein the first movable part 110 is shown in dashed lines for illustrative purposes.

As described above, the guide rod 421 of the second guiding assembly 420 is movably received between the second guiding groove 423 of the second movable part 120 and the second guiding groove 425 of the first movable part 110, and the guide rod 422 is movably received between the second guiding groove 424 of the second movable part 120 and the second guiding groove 426 of the first movable part 110. Since the second guiding grooves 423, 424, 425, and 426 extend in the direction of the second axis O2, the second movable part 120 drives the third movable part 130 and the optical element 10 to move relative to the first movable part 110 along the second axis O2.

FIG. 11 is a right side view of the optical element driving mechanism 1 according to certain aspects of the present disclosure, wherein a portion of the fixed part 200 is removed and the base 220 is shown in dashed lines for illustrative purposes.

As described above, the ball 411 of the first guiding assembly 410 is movably received between the first guiding groove 414 of the first movable part 110 and the first guiding groove 417 of the base 220, the ball 412 is movably received between the first guiding groove 415 of the first movable part 110 and the first guiding groove 418 of the base 220, and the ball 413 is movably received between the first guiding groove 416 of the first movable part 110 and the first guiding groove 419 of the base 220. Since the first guiding grooves 414, 415, 416, 417, 418, and 419 extend in the direction of the first axis O1, the first movable part 110 drives the second movable part 120, the third movable part 130, and the optical element 10 to move relative to the fixed part 200 along the first axis O1.

FIG. 12 is a perspective view of the optical element driving mechanism 1, the optical element 10, and the aperture assembly 20 according to certain aspects of the present disclosure, wherein a portion of the fixed part 200 is removed and the base 220 is shown in dashed lines for illustrative purposes.

By an electromagnetic driving force generated between the first driving unit 310 and the second driving unit 320 along the first axis O1, the first driving unit 310 moves relative to the second driving unit 320 along the first axis O1, and the first movable part 110 moves relative to the fixed part 200 along the first axis O1 via the first guiding assembly 410, thereby driving the second movable part 120, the third movable part 130, and the optical element 10.

Since the second sensing element 740 senses variations of the magnetic field of the second reference element 730 along the second axis O2, and the third sensing element 760 senses variations of the magnetic field of the third reference element 750 along the third axis O3, movement along the first axis O1 affects only sensing results of the first sensing element 720.

By an electromagnetic driving force generated between the third driving unit 330 and the fourth driving unit 340 along the second axis O2, the third driving unit 330 moves relative to the fourth driving unit 340 along the second axis O2, and the second movable part 120 moves relative to the first movable part 110 along the second axis O2 via the second guiding assembly 420, thereby driving the third movable part 130 and the optical element 10.

Since the first sensing element 720 senses variations of the magnetic field of the first reference element 710 along the first axis O1, and the third sensing element 760 senses variations of the magnetic field of the third reference element 750 along the third axis O3, movement along the second axis O2 affects only sensing results of the second sensing element 740.

By an electromagnetic driving force generated between the fifth driving unit 350 and the sixth driving unit 360 along the third axis O3, the fifth driving unit 350 moves relative to the sixth driving unit 360 along the third axis O3, and the third movable part 130 moves relative to the second movable part 120 along the third axis O3 via the third guiding assembly 430, thereby driving the optical element 10.

Since the second sensing element 740 senses variations of the magnetic field of the second reference element 730 along the second axis O2, and the first sensing element 720 senses variations of the magnetic field of the first reference element 710 along the first axis O1, movement along the third axis O3 affects only sensing results of the third sensing element 760.

In other words, sensing by the first sensing element 720 is affected only by movement along the first axis O1 and is not affected by movement along other axes (e.g., the second axis O2 or the third axis O3). Sensing by the second sensing element 740 is affected only by movement along the second axis O2 and is not affected by movement along other axes (e.g., the first axis O1 or the third axis O3). Sensing by the third sensing element 760 is affected only by movement along the third axis O3 and is not affected by movement along other axes (e.g., the second axis O2 or the first axis O1).

Therefore, the first movable part 110 is movable relative to the fixed part 200 in the first dimension along the first axis O1. The first movable part 110 drives both the second movable part 120 and the third movable part 130.

The second movable part 120 is movable relative to the fixed part 200 in the first dimension along the first axis O1 and in the second dimension along the second axis O2. The second movable part 120 is movable relative to the first movable part 110 in the second dimension along the second axis O2. The second movable part 120 drives the third movable part 130.

The third movable part 130 is movable relative to the fixed part 200 in the first dimension along the first axis O1, in the second dimension along the second axis O2, and in the third dimension along the third axis O3. The third movable part 130 is movable relative to the second movable part 120 in the third dimension along the third axis O3. The third movable part 130 is movable relative to the first movable part 110 in the second dimension along the second axis O2 and in the third dimension along the third axis O3.

However, when the third movable part 130 moves in the third dimension along the third axis O3, the third movable part 130 does not drive the first movable part 110 or the second movable part 120. When the second movable part 120 moves in the second dimension along the second axis O2, the second movable part 120 does not drive the first movable part 110.

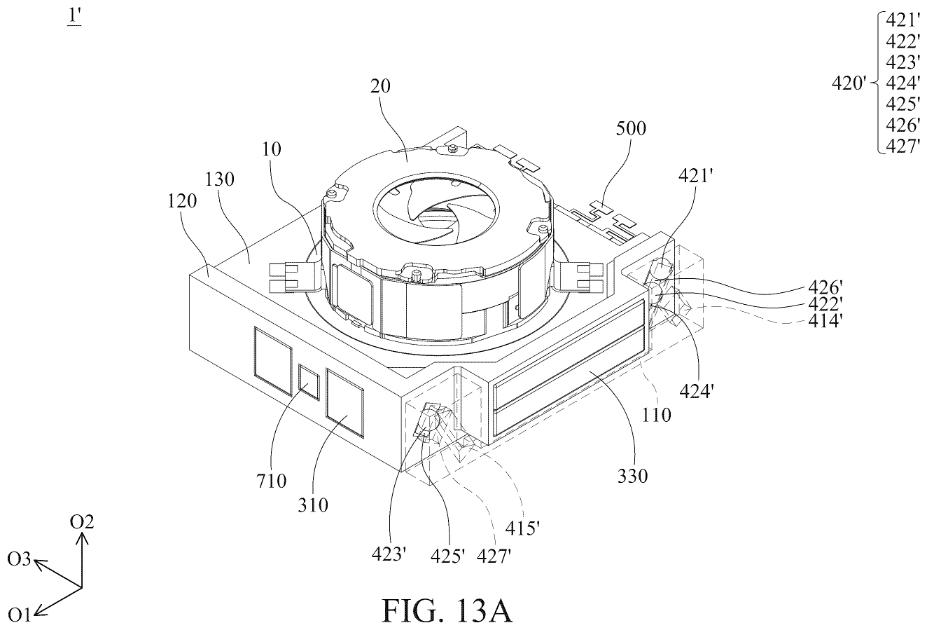

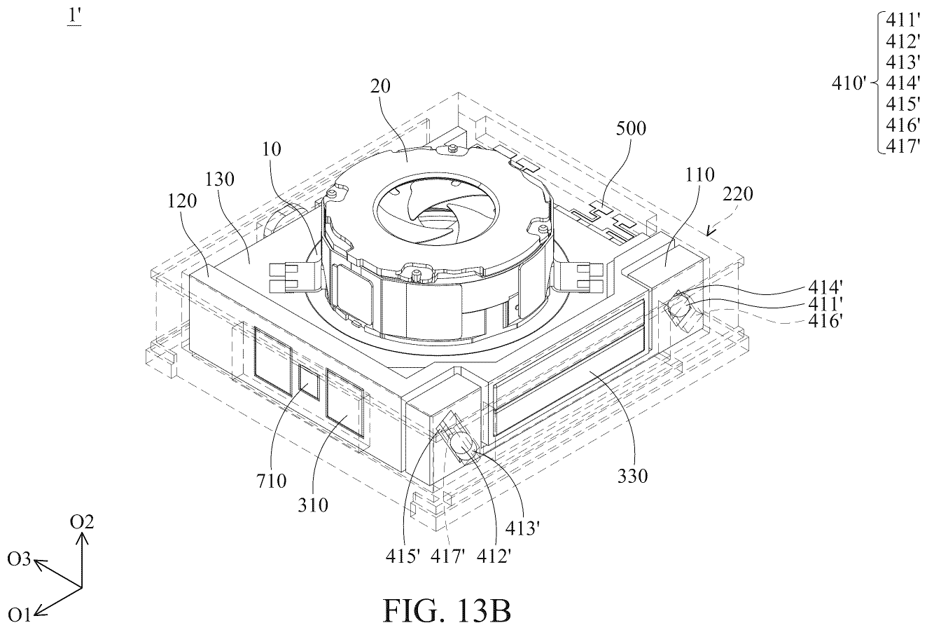

Please refer next to FIGS. 13A and 13B. The configurations of another optical element driving mechanism 1′ are illustrated. FIG. 13A is a perspective view of the other optical element driving mechanism 1′, the optical element 10, and the aperture assembly 20 according to certain aspects of the present disclosure, wherein, for illustrative purposes, the fixed part 200 and the first guiding assembly 410′ are removed, and the first movable part 110 is shown in dashed lines.

The optical element driving mechanism 1′ in FIG. 13A is generally similar to the optical element driving mechanism 1 in FIG. 12, where components having similar functions are represented by similar reference numerals (e.g., the second guiding assembly 420′ of the optical element driving mechanism 1′ is similar to the second guiding assembly 420 of the optical element driving mechanism 1), and components that are identical are represented by identical reference numerals (e.g., the third movable part 130 of the optical element driving mechanism 1′ is identical to the third movable part 130 of the optical element driving mechanism 1).

In the optical element driving mechanism 1′, the second guiding assembly 420′ includes a combination of three balls 421′, 422′, and 423′ located in four second guiding grooves. Among them, second guiding grooves 424′ and 425′ are disposed on the second movable part 120, and second guiding grooves 426′ and 427′ are disposed on the first movable part 110. The second movable part 120 is movable relative to the first movable part 110 via the second guiding assembly 420′. In the present embodiment, the second guiding grooves 424′, 425′, 426′, and 427′ have elongated structures extending at a first angle between the first axis O1 and the second axis O2, thereby enabling the second movable part 120 to move relative to the first movable part 110 in a dimension along the first angle.

FIG. 13B is a perspective view of the other optical element driving mechanism 1′ according to certain aspects of the present disclosure, wherein, for illustrative purposes, a portion of the fixed part 200 is removed and the base 220 is shown in dashed lines.

In the optical element driving mechanism 1′, the first guiding assembly 410′ includes a combination of three balls 411′, 412′, and 413′ located in four first guiding grooves. Among them, first guiding grooves 414′ and 415′ are disposed on the first movable part 110, and first guiding grooves 416′ and 417′ are disposed on the base 220. The first movable part 110 is movable relative to the base 220 via the first guiding assembly 410′. In the present embodiment, the first guiding grooves 414′, 415′, 416′, and 417′ have elongated structures extending at a second angle between the first axis O1 and the second axis O2, thereby enabling the second movable part 120 to move relative to the first movable part 110 in a dimension along the second angle.

By an electromagnetic driving force generated between the first driving unit 310 and the second driving unit 320 along the first axis O1, the first driving unit 310 moves relative to the second driving unit 320 along the first axis O1, and the first movable part 110 moves relative to the fixed part 200 along the first axis O1 via simultaneous actions of the first guiding assembly 410′ and the second guiding assembly 420′, thereby driving the second movable part 120, the third movable part 130, and the optical element 10.

Similarly, by an electromagnetic driving force generated between the third driving unit 330 and the fourth driving unit 340 along the second axis O2, the third driving unit 330 moves relative to the fourth driving unit 340 along the second axis O2, and the second movable part 120 moves relative to the first movable part 110 along the second axis O2 via simultaneous actions of the first guiding assembly 410′ and the second guiding assembly 420′, thereby driving the third movable part 130 and the optical element 10.

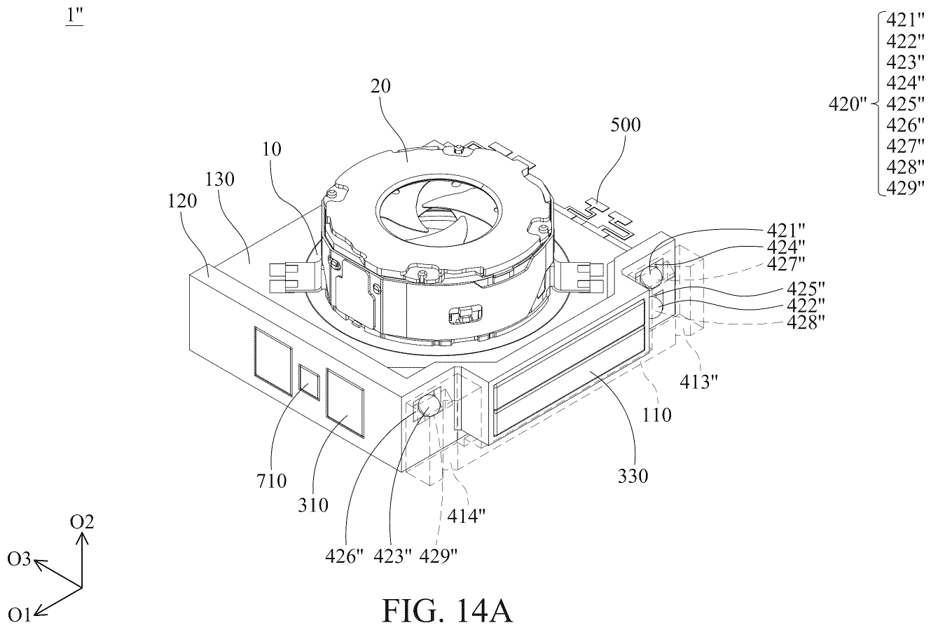

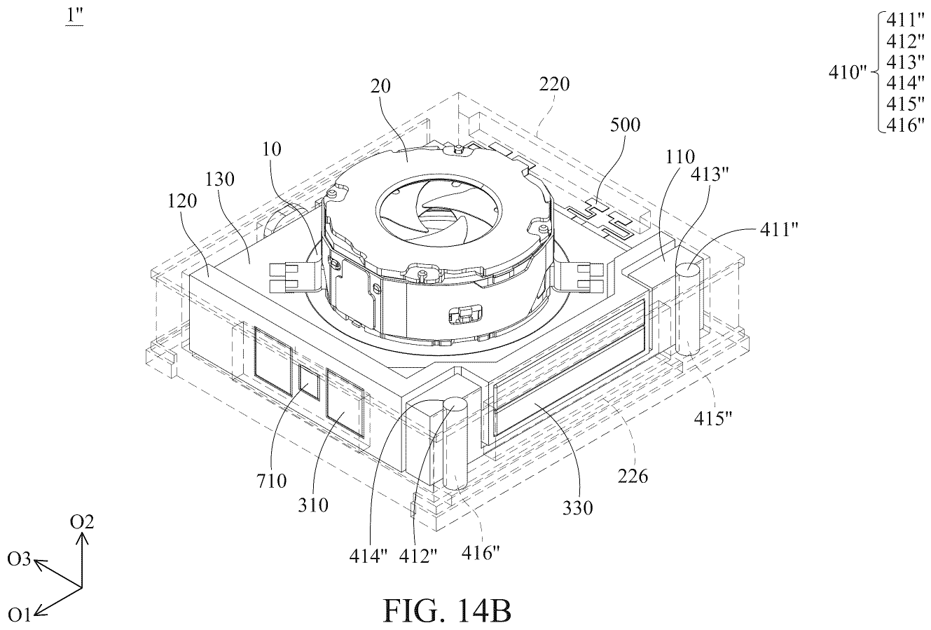

Please refer next to FIGS. 14A and 14B. The configurations of yet another optical element driving mechanism 1″ are illustrated. FIG. 14A is a perspective view of the optical element driving mechanism 1″ according to certain aspects of the present disclosure, wherein, for illustrative purposes, the fixed part 200 and the first guiding assembly 410″ are removed, and the first movable part 110 is shown in dashed lines.

The optical element driving mechanism 1″ in FIG. 14A is generally similar to the optical element driving mechanism 1 in FIG. 12. Components having similar functions are represented by similar reference numerals (e.g., the second guiding assembly 420″ of the optical element driving mechanism 1″ is similar to the second guiding assembly 420 of the optical element driving mechanism 1), and components that are identical are represented by identical reference numerals (e.g., the third movable part 130 of the optical element driving mechanism 1″ is identical to the third movable part 130 of the optical element driving mechanism 1).

In the optical element driving mechanism 1″, the second guiding assembly 420″ includes a combination of three balls 421″, 422″, and 423″ located in six second guiding grooves. Among them, second guiding grooves 424″, 425″, and 426″ are disposed on the second movable part 120, and second guiding grooves 427″, 428″, and 429″ are disposed on the first movable part 110. The second movable part 120 is movable relative to the first movable part 110 via the second guiding assembly 420″. In the present embodiment, the second guiding grooves 424″, 425″, 426″, 427″, 428″, and 429″ have elongated structures extending along the first axis O1, thereby enabling the second movable part 120 to move relative to the first movable part 110 in a dimension along the first axis O1.

FIG. 14B is a perspective view of the optical element driving mechanism 1″ according to certain aspects of the present disclosure, wherein, for illustrative purposes, a portion of the fixed part 200 is removed and the base 220 is shown in dashed lines.

In the optical element driving mechanism 1″, the first guiding assembly 410″ includes a combination of two guide rods 411″ and 412″ located in four first guiding grooves. Among them, first guiding grooves 413″ and 414″ are disposed on the first movable part 110, and first guiding grooves 415″ and 416″ are disposed on the base 220. The first movable part 110 is movable relative to the base 220 via the first guiding assembly 410″. In the present embodiment, the first guiding grooves 414″, 415″, 416″, and 417″ have elongated structures extending along the second axis O2, thereby enabling the first movable part 110 to move relative to the fixed part 200 in a dimension along the second axis O2.

By an electromagnetic driving force generated between the first driving unit 310 and the second driving unit 320 along the first axis O1, the first driving unit 310 moves relative to the second driving unit 320 along the first axis O1, and the second movable part 120 moves relative to the first movable part 110 along the first axis O1 via the second guiding assembly 420″, thereby driving the third movable part 130 and the optical element 10.

Similarly, by an electromagnetic driving force generated between the third driving unit 330 and the fourth driving unit 340 along the second axis O2, the third driving unit 330 moves relative to the fourth driving unit 340 along the second axis O2, and the first movable part 110 moves relative to the fixed part 200 along the second axis O2 via the first guiding assembly 410″, thereby driving the second movable part 120, the third movable part 130, and the optical element 10.

In summary, the present invention provides an optical element driving mechanism including a plurality of movable parts, a fixed part, a driving assembly, a circuit assembly, a plurality of guiding assemblies, and a sensing assembly. Movement of the driving assembly drives the plurality of movable parts to move relative to one another and to the fixed part. Accordingly, a position of the optical element can be adjusted to accommodate different photographing requirements and to provide improved optical stability and image quality.

Although one or more embodiments of the present disclosure have been illustrated and described with respect to certain implementations, those skilled in the art, upon reading and understanding this specification and the accompanying drawings, will envision equivalents and modifications. In addition, although specific features of the invention may have been disclosed with respect to only one embodiment among several possible embodiments, such features may, as needed and advantageous for any given or particular application, be combined with one or more other features of other embodiments.

Although various embodiments of the present invention have been described above, it should be understood that these embodiments are presented merely by way of example and not by way of limitation. Various modifications may be made to the embodiments disclosed herein without departing from the spirit or scope of the present invention. Therefore, the breadth and scope of the present invention should not be limited by any of the above-described embodiments. Instead, the scope of the present invention should be defined in accordance with the following claims and their equivalents.

The terminology used herein is for the purpose of describing particular embodiments only and is not intended to limit the present invention. As used herein, the singular forms “a,” “an,” and “the” are intended to include the plural forms as well, unless the context clearly indicates otherwise. Furthermore, the terms “including,” “includes,” “having,” “has,” “with,” or variations thereof, as used in the embodiments and/or the claims, are intended to be interpreted in a manner similar to the term “comprising.”

What is claimed is:

1. An optical element driving mechanism, comprising:
a first movable part, configured to connect to an optical element;
a fixed part, wherein the first movable part is movable relative to the fixed part in a first dimension; and
a driving assembly configured to drive the first movable part to move.

2. The optical element driving mechanism as claimed in claim 1, further comprising a second movable part, wherein:
the second movable part is movable relative to the first movable part in a second dimension; and
the second movable part is movable relative to the fixed part in the first dimension and the second dimension.

3. The optical element driving mechanism as claimed in claim 2, wherein the second movable part comprises:
a body; and
an installation portion, extending from the body toward a recess of the first movable part, wherein
the second movable part and the first movable part are arranged along a first axis;
the second movable part and the fixed part are arranged along a second axis; and
when viewed along a third axis, the first movable part and the second movable part at least partially overlap.

4. The optical element driving mechanism as claimed in claim 3, wherein:
the first axis, the second axis, and the third axis are non-parallel; and
the second axis is parallel to a principal axis of the optical element.

5. The optical element driving mechanism as claimed in claim 3, further comprising:
a first guiding assembly, disposed between the first movable part and the fixed part, the first movable part being movable relative to the fixed part via the first guiding assembly; and
a second guiding assembly, disposed between the second movable part and the first movable part, the second movable part being movable relative to the first movable part via the second guiding assembly,
wherein the first guiding assembly and the second guiding assembly are arranged along the third axis.

6. The optical element driving mechanism as claimed in claim 5, wherein:
the first guiding assembly comprises a plurality of first guiding grooves, wherein the first guiding grooves are disposed on the first movable part and the fixed part;
the second guiding assembly comprises a plurality of second guiding grooves, wherein the second guiding grooves are disposed on the first movable part and the second movable part; and
the third guiding assembly comprises a plurality of third guiding grooves, wherein the third guiding grooves are disposed on the second movable part.

7. The optical element driving mechanism as claimed in claim 5, further comprising a sensing assembly, configured to sense movement of the optical element relative to the fixed part, wherein the sensing assembly comprises:
a first reference element;
a first surface, having a normal vector parallel to the first axis; and
a first sensing element, corresponding to the first reference element and configured to sense movement of the optical element along the first axis, wherein
the first surface faces the first sensing element.

8. The optical element driving mechanism as claimed in claim 7, wherein the first reference element comprises:
a first N pole; and
a first S pole, the first S pole and the first N pole being arranged along the first axis, wherein
along the first axis, the first sensing element at least partially overlaps the first N pole.

9. The optical element driving mechanism as claimed in claim 8, wherein the sensing assembly further comprises:
a second reference element, disposed on the second movable part; and
a second sensing element, disposed on the fixed part, corresponding to the second reference element and configured to sense movement of the optical element along the second axis, wherein
the second surface faces the second sensing element; and
when viewed along the third axis, the second reference element and the second sensing element at least partially overlap.

10. The optical element driving mechanism as claimed in claim 9, wherein the second reference element comprises:
a second surface, parallel to the second axis;
a second N pole;
a second S pole, arranged with the second N pole along the third axis;
a third N pole; and
a third S pole, arranged with the third N pole along the third axis, wherein
an arrangement direction of the third S pole and the third N pole is opposite to an arrangement direction of the second S pole and the second N pole.

11. The optical element driving mechanism as claimed in claim 6, further comprising:
a first stabilizing assembly, configured to generate a first stabilizing force applied to the second movable part to bias the second movable part toward the fixed part, wherein
when the first stabilizing force is applied to the second movable part, the first movable part is biased toward the fixed part.

12. The optical element driving mechanism according to claim 11, wherein a direction of the first stabilizing force is not parallel to the second axis.

13. The optical element driving mechanism as claimed in claim 11, further comprising:
a third movable part, configured to connect to an optical element, wherein the third movable part is movable relative to the second movable part, the first movable part, and the fixed part; and
a second stabilizing assembly, configured to generate a second stabilizing force applied to the third movable part to bias the third movable part toward the second movable part, wherein
the direction of the first stabilizing force is non-parallel to a direction of the second stabilizing force; and
the third guiding grooves are disposed on the third movable part and the second movable part.

14. The optical element driving mechanism as claimed in claim 13, wherein the driving assembly comprises:
a first driving unit, fixedly disposed on the second movable part;
a second driving unit, corresponding to the first driving unit;
a third driving unit, fixedly disposed on the second movable part;
a fourth driving unit, corresponding to the third driving unit;
a fifth driving unit, fixedly disposed on the third movable part; and
a sixth driving unit, corresponding to the fifth driving unit.

15. The optical element driving mechanism as claimed in claim 14, wherein when viewed along the second axis, the fixed part has a polygonal shape, and comprising:
a first side, on which the second driving unit is disposed;
a second side, on which the fourth driving unit is disposed; and
a third side, on which the sixth driving unit is disposed, wherein
the first side and the second side are non-parallel.

16. The optical element driving mechanism as claimed in claim 15, wherein the fixed part further comprises a fourth side, and the first side, the second side, the third side, and the fourth side form the polygonal shape.

17. The optical element driving mechanism as claimed in claim 16, further comprising:
a circuit assembly, configured to connect to an external circuit, wherein
when viewed along the second axis, the circuit assembly is located on the fourth side.

18. The optical element driving mechanism as claimed in claim 17, wherein the circuit assembly comprises:
a first movable part connection terminal, at least partially fixedly connected to the first movable part, the second movable part, or the third movable part;
a first fixed part connection terminal, at least partially fixedly connected to the fixed part; and
a first elastic portion, wherein the first movable part connection terminal is connected to the first fixed part connection terminal via the first elastic portion.

19. The optical element driving mechanism according to claim 18, wherein the circuit assembly further comprises:
a second fixed part connection terminal, at least partially fixedly connected to the fixed part; and
a third fixed part connection terminal, at least partially fixedly connected to the fixed part, wherein
when viewed along the second axis, the first fixed part connection terminal, the second fixed part connection terminal, and the third fixed part connection terminal are all disposed on the fourth side.

20. The optical element driving mechanism according to claim 19, wherein:
the second fixed part connection terminal is electrically independent from the first fixed part connection terminal; and
the third fixed part connection terminal is electrically independent from the first fixed part connection terminal and the second fixed part connection terminal.
